(19) United States
(12) Patent Application Publication
(10) Pub. No.: US 2006/0000929 A1
(43) Pub. Date: Jan. 5, 2006

(54) Chemical application apparatus and chemical application method

(75) Inventor: Hideaki Mito, Niigata (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/144,683

(22) Filed: Jun. 6, 2005

(30) Foreign Application Priority Data
Jun. 18, 2004 (JP) 2004-181031

(51) Int. Cl. A01G 27/00; A62C 13/62; B05B 1/32; A62C 13/66

(52) U.S. Cl. 239/451; 239/302; 239/67; 239/69

(57) ABSTRACT

A chemical application apparatus includes: holding section for holding a substrate, and an application nozzle which is capable of moving over the substrate held by the holding section and which supplies a chemical onto the surface of the substrate. Further, it includes: storage section for storing pattern information for forming a pattern on the substrate; position computing section for computing a relative position of the application nozzle with respect to a measurement mark provided on the substrate; and control section for forming the pattern by applying the chemical onto the substrate through the application nozzle based on the relative position and the pattern information.

### CROSS REFERENCE TO RELATED APPLICATIONS

This Non-provisional application claims priority under 35 U.S.C. § 119(a) on Patent Application No. 2004-181031 filed in Japan on Jun. 18, 2004, and Patent Application No. 2005-128954 filed in Japan on Apr. 27, 2005, the entire contents of which are hereby incorporated by reference.

### FIELD OF THE INVENTION

The present invention relates to a chemical application apparatus and a method for applying a chemical used in manufacturing a semiconductor device and the like.

### DESCRIPTION OF THE PRIOR ART

In conventional chemical application apparatuses and methods in manufacturing a semiconductor device, rotation application is performed in which a chemical is applied onto the surface of a substrate while the substrate is rotated. In manufacturing a liquid crystal panel, scanning application or the like is performed in which chemical is applied onto the surface of a substrate while a chemical applying nozzle is moved over the substrate (see, for example, Japanese Patent Application Laid Open Publication No. 8-250389A).

Conventional chemical application apparatus and chemical application method will be described below with reference to FIG. 6. FIG. 6 is a section showing a main part of the conventional chemical application apparatus.

As shown in FIG. 6, a wafer chuck 46 sucks and vacuums a substrate 41 conveyed to an application unit to hold it substantially horizontally. Next, an application nozzle 43 arranged above the substrate 41 and being capable of moving over the entirety of the substrate 41 is allowed to move from one end to the other end of the substrate 41 over the substrate 41. Under the circumstances, based on dropping start point information and dropping end point information stored in a computer 45 for storing application area information, dropping of a chemical 48 is started at the time when the application nozzle 43 reaches a chemical dropping start point above the substrate 41, and then, the dropping of the chemical 48 is stopped at the time when the application nozzle 43 reaches a chemical dropping end point above the substrate 41. Wherein, the thickness of the chemical 48 applied is adjusted according to chemical viscosity and the like.

### SUMMARY OF THE INVENTION

In the above conventional technique, however, it is necessary, after applying the chemical such as a photosensitive resin onto the substrate, to perform exposure and development to the applied chemical, resulting in invitation to a complicated equipment structure and in increase in processing time period.

The present invention has been made in view of the above problems and has its object of performing pattern formation within a short period of time without using equipment having a complicated structure.

To attain the above object, a chemical application apparatus according to the present invention includes: holding means which holds a substrate; an application nozzle which is capable of moving over the substrate held by the holding means and which supplies a chemical onto a surface of the substrate; storage means which stores pattern information for forming a pattern on the substrate; position computing means which computes a relative position of the application nozzle with respect to a measurement mark provided on the substrate; and control means which forms the pattern by applying the chemical onto the substrate through the application nozzle based on the relative position computed by the position computing means and the pattern information stored in the storage means.

In the chemical application apparatus of the present invention, the application nozzle preferably includes a discharge port for discharging the chemical, a discharge port for discharging a solvent that dissolves the chemical, a sucking port for sucking a waste fluid, and a discharge port for discharging a gas.

In the chemical application apparatus of the present invention, the application nozzle preferably includes a plurality of application nozzles, each of which is drive controlled independently.

A chemical application method according to the present invention includes: a step (a) of storing pattern information for forming a pattern on a substrate into storage means; a step (b) of computing a relative position of an application nozzle with respect to a measurement mark provided on the substrate; and a step (c) of forming the pattern by applying a chemical onto the substrate through the application nozzle based on the relative position and the pattern information.

In the chemical application method of the present invention, the step (c) preferably includes the step of overlaying the chemical in a predetermined region by moving the application nozzle so as to pass along the predetermined region.

In the chemical application method of the present invention, the step (c) preferably includes the step of applying two or more kinds of chemicals onto the substrate through the application nozzle.

In the chemical application method of the present invention, the step (c) preferably includes the step of applying a solvent for dissolving the chemical onto the substrate through the application nozzle while removing excessive part of the chemical applied onto the substrate based on the pattern information. In this case, the step (c) preferably includes the step of removing by sucking the chemical dissolved in the solvent through the application nozzle.

In the present invention, the drive control and the chemical supply control on the application nozzle are performed based on the computed result of the relative position of the application nozzle with respect to measurement marks on the substrate and the pattern information prepared in advance, thereby forming a pattern on the substrate. Therefore, in pattern formation even using a chemical of, for example, a photosensitive resin and the like, a desired pattern can be formed on the substrate in chemical application with the need for an exposure process and a development process eliminated.

As described above, the present invention relates to a chemical application apparatus and a chemical application method, and attains an effect that pattern formation can be performed within a short period of time without using equipment complicated in structure in a case applied to a lithography process in manufacturing a semiconductor device or to a manufacturing process of a liquid crystal panel, which is very useful.

### BRIEF DESCRIPTION OF THE DRAWINGS

FIG. 1 is a plan view of a main part of a chemical application apparatus according to Embodiment 1 of the present invention.

FIG. 2 is a section of the main part of the chemical application apparatus according to Embodiment 1 of the present invention.

FIG. 3 is a view showing in detail an application nozzle of the chemical application apparatus according to Embodiment 1 of the present invention.

FIG. 4 is a plan view of a main part of a chemical application apparatus according to Embodiment 2 of the present invention.

FIG. 5 is a plan view of a main part of a chemical application apparatus according to Embodiment 3 of the present invention.

FIG. 6 is a section of a main part of a conventional chemical application apparatus.

### DETAILED DESCRIPTION OF THE INVENTION

### Embodiment 1

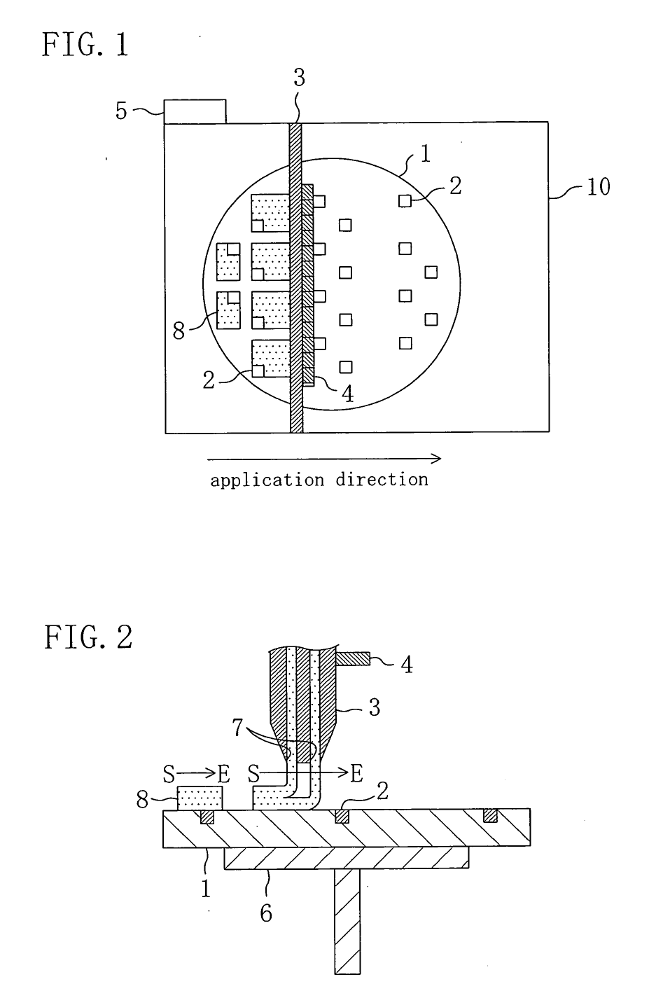

A chemical application method and a chemical application apparatus according to Embodiment 1 of the present invention will be described below with reference to FIG. 1 and FIG. 2.

FIG. 1 is a plan view of a main part of the chemical application apparatus according to Embodiment 1, and FIG. 2 is a section of the main part of the chemical application apparatus according to Embodiment 1.

As shown in FIG. 1 and FIG. 2, the chemical application apparatus (application unit) of the present embodiment includes: a wafer chuck 6 for holding a substrate 1; an application nozzle 3 for applying a chemical 8 onto the substrate 1 held by the wafer chuck 6; a substrate position measuring mechanism 4 that computes a relative position of the application nozzle 3 with respect to measurement marks 2 provided on the substrate 1; a computer 5 that stores pattern information for forming a pattern on the substrate 1; and means for performing drive control and chemical supply control on the application nozzle 3 based on the relative position computed by the substrate position measuring mechanism 4 and the pattern information stored in the computer 5 (for example, this means may be another computer not shown or the computer 5 may serve as this means in addition). The application nozzle 3 is arranged above the substrate 1 held by the wafer chuck 6 and is capable of moving over the entirety of the substrate 1. Specifically, the application nozzle 3 can move in a predetermined application direction (X direction) over the substrate 1 and extends in a Y direction perpendicular to the X direction so as to cross over the substrate 1. The length of the application nozzle 3 in the Y direction (extending direction) is longer than the diameter of a wafer to be the substrate 1. The substrate position measuring mechanism 4 is mounted on one side face extending in the Y direction of the application nozzle 3. Wherein, the location of the substrate position measuring mechanism 4 is not limited specifically only if the relative position of the application nozzle 3 with respect to the measurement marks 2 can be measured. The computer 5 is mounted on a outer cabinet wall 10 of the application unit, for example.

The chemical application method using the chemical application apparatus (application unit) of the present embodiment shown in FIG. 1 and FIG. 2 will be descried below. Wherein, the pattern information is stored in the computer 5 in advance before the chemical application processing.

First, the wafer chuck 6 sucks and vacuums the substrate 1 conveyed to the application unit to held it substantially horizontally. Next, the substrate position measuring mechanism 4 mounted on the application nozzle 3 measures the positions of the measurement marks 2 provided on the substrate 1 (specifically, relative positions of the measurement marks 2 viewed from a reference position (zero point) in the application unit). It is noted that the reference position can be set arbitrarily and the position of the application nozzle 3 may be set as the reference position, for example.

The measurement marks 2, of which number is preferably 4 and at least 2, are provided on the substrate. The substrate position measuring mechanism 4 measures position information on the X direction and the Y direction of each measurement mark 2. The substrate position measuring mechanism 4 then performs processing of averaging the measured values to compute the relative position of the application nozzle 3 with respect to the measurement marks 2. Under the circumstances, weighting processing is performed to the measured values of the position information of each measurement mark 2 to attain optimum alignment (in other words, accurate computation of the relative position of the application nozzle 3 with respect to the measurement marks 2). Specifically, when computation accuracy of the relative position of the application nozzle 3 varies depending on the measurement marks 2, a greater weight is applied to the measured value of the position information of a measurement marks 2 from which higher accuracy can be obtained. For example, when measurement mark processing accuracy in the peripheral portion of the substrate 1 is inferior to measurement mark processing accuracy in the central portion of the substrate 1, a greater weight is applied to the measured value of the position information of a measurement mark 2 provided in the central portion of the substrate 1, thereby increasing the computation accuracy of the relative position of the application nozzle 3.

Further, the substrate position measuring mechanism 4 measures the positions of the measurement marks 2 by exchanging diffracted light of laser light and image recognition by an image sensor utilized or the like according to the surface state of the substrate 1. Further, the substrate position measuring mechanism 4 can perform correction of the measured position information of the measurement marks 2 based on a measured result of an overlap state of an underlying pattern and an applied pattern (pattern formed by drying the applied chemical 8) on the substrate 1 after chemical application.

Next, the application nozzle 3 is allowed to move from one end to the other end of the substrate 1 over the substrate 1. Under the circumstances, based on the pattern information stored in the computer 5 for pattern information storage and the relative position information of the application nozzle 3 computed by the substrate position measuring mechanism 4, dropping of the chemical 8 through the application nozzle 3 is started at a time when the application nozzle 3 reaches a chemical dropping start point S above the substrate 1, and thereafter, the dropping of the chemical 8 through the application nozzle 3 is stopped at the time when the application nozzle 3 reaches a chemical dropping end point E above the substrate 1, as shown in FIG. 2. Wherein, drive control and the chemical supply control on the application nozzle 3 are performed using the computer 5, for example. Further, the thickness of the chemical 8 applied on the substrate 1 is adjusted according to viscosity of the chemical 8, movement speed of the application nozzle 3, whether or not the chemical 8 is being dropped from a nozzle array 7 (described later), and the like. In addition, whether the chemical 8 is to be applied or not in the extending direction (the direction perpendicular to the application direction) of the application nozzle 3 is adjusted by controlling the dropping of the chemical 8 from each chemical discharge port of the nozzle array 7 (control to drop the chemical 8 from given discharge ports while not to drop the chemical 8 from other discharge ports). Wherein, the number of the discharge ports composing the nozzle array 7 indicated in FIG. 2 is smaller than the number of the actually provided ports.

As described above, in Embodiment 1 of the present invention, the drive control and the chemical supply control on the application nozzle 3 are performed, based on the computed result of the relative position of the application nozzle 3 with respect to the measurement marks 2 on the substrate 1 and the pattern information stored in the computer 5, thereby forming a pattern on the substrate 1. Accordingly, the chemical 8 can be applied only in a desired region on the substrate 1 by the application nozzle 3, so that an exposure process and a development process can be eliminated in a case of pattern formation using a photosensitive resin as the chemical 8. Further, pattern formation using a non-photosensitive resin as the chemical 8 can be enabled. Hence, a pattern can be formed within a short period of time without using equipment having a complicated structure.

The application nozzle 3 including the nozzle array 7 in the present embodiment will be described below in detail.

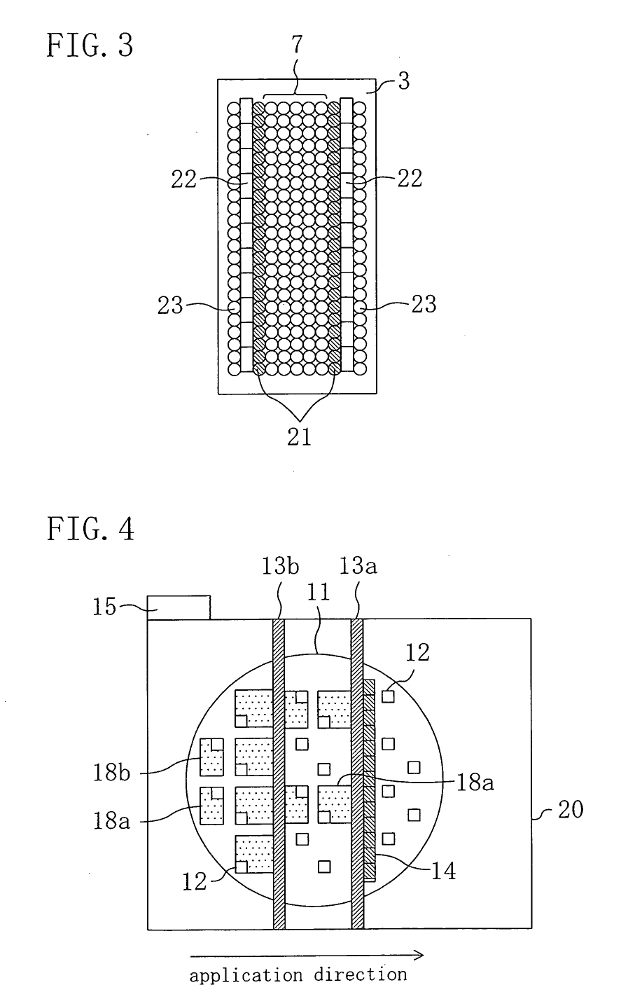

FIG. 3 shows in detail the application nozzle 3 in the present embodiment, specifically, is an enlarged view of a face (hereinafter referred to as a discharge face) of the application nozzle 3 which faces the substrate 1 (substrate 1 held by the wafer chuck 6). Wherein, the extending direction of the application nozzle 3 is shortened in dimension in the drawing, compared with the actual dimension.

As shown in FIG. 3, the application nozzle 3 includes: a nozzle array 7 composed of a plurality of discharge ports formed in the central portion of the discharge face for discharging the chemical 8; solvent (solvent for dissolving the chemical 8) discharge ports 21 formed on the respective sides of the nozzle array 7 in the discharge face; waste fluid sucking ports 22 formed in the discharge face on the respective end sides of the discharge face viewed from the solvent discharge ports 21; and high-pressure gas discharge ports 23 formed in the discharge face on the respective end sides of the discharge face viewed from the waste fluid sucking port 22.

Operation of the application nozzle 3 shown in FIG. 3 is as follows. First, at the time when the application nozzle 3 reaches the chemical dropping start point S (see FIG. 2) above the substrate 1, the chemical 8 is dropped onto the substrate 1 through the nozzle array 7. Under the circumstances, in order to prevent the chemical 8 from flowing outside a region where the chemical 8 is to be applied, a solvent for dissolving the chemical 8 is dropped onto the substrate 1 from the solvent discharge ports 21 while the solvent and excessive chemical 8 are sucked and removed through the waste fluid sucking ports 22.

During the time when the application nozzle 3 moves in the chemical application region (region from the chemical dropping start point S to the chemical dropping end point E), the chemical 8 is dropped onto the substrate 1 from the nozzle array 7. At this time, clean high-pressure nitrogen may be blown, as necessary, to the substrate 1 from the high-pressure (pressure higher than atmosphere (atmospheric pressure)) gas discharge ports 23 to accelerate drying of the chemical 8 applied in the chemical application region and to prevent the chemical 8 from flowing out to a non-application region (“a region where the chemical 8 is not to be applied” according to the pattern information stored in the computer 5).

Subsequently, at the time when the application nozzle 3 reaches the chemical application dropping end point E (see FIG. 2) above the substrate 1, the chemical dropping from the nozzle array 7 is stopped. At that time (when the chemical dropping is stopped), in order to prevent unnecessary pattern from being formed by solidification of the chemical 8 flowing from the chemical application region toward the outside thereof, a solvent capable of liquefying the solidified chemical 8 is dropped onto the substrate 1 from the solvent discharge ports 21 while the solvent and liquefied chemical 8 are sucked and removed through the waste fluid sucking ports 22. At that time, in addition, clean high-pressure nitrogen is blown to the substrate 1 from the high-pressure gas discharge ports 23 to accelerate drying of the chemical 8 applied in the chemical application region and to prevent the chemical 8 from flowing toward the non-application region.

As described above, in Embodiment 1, the application nozzle 3 repeats the aforementioned operation, thereby applying the chemical 8 accurately in a desired region on the substrate 1.

It is noted that in Embodiment 1, the number of times of the movement of the application nozzle 3 from the one end to the other end of the substrate 1 over the substrate 1 is not limited to 1. Namely, the chemical 8 is overlaid in the chemical application region by moving the application nozzle 3 so as to pass along the chemical application region more than one time, obtaining a desired thickness of the applied chemical 8.

The wafer chuck 6 is not driven in Embodiment 1. However, it is possible that a motor is provided to rotate, at a desired number of rotation, the wafer chuck 6 together with the substrate 1 to dry the substrate 1.

Furthermore, in Embodiment 1, plural kinds of chemicals may be dropped onto the substrate 1 from the nozzle array 7 of the application nozzle 3. For example, plural kinds of chemicals different in property from each other, such as a chemical for underlying anti-reflection film formation, a chemical for resist formation, and a chemical for overlying anti-reflection film formation, may be dropped sequentially onto the substrate 1.

Moreover, in Embodiment 1, it is possible that a plurality of application nozzles are used or a plurality of nozzle arrays are provided in one or more application nozzles to apply the chemicals while changing the thickness of the resultant applied chemical region by region on the substrate 1. Alternatively, a negative resist and a positive resist may be applied separately in corresponding regions. By doing so, plural kinds of chemicals having different properties can be separately applied respectively in desired regions on the substrate 1, reducing time required for chemical application remarkably. In addition, even in the case where the present invention is applied to pattern formation by electron beam lithography, a chemical can be applied onto the substrate 1 selectively and respective resists different in kind can be applied to respective regions, enhancing the throughput.

### Embodiment 2

A chemical application method and a chemical application apparatus according to Embodiment 2 of the present invention will be described below with reference to the drawings.

FIG. 4 is a plan view of a main part of the chemical application apparatus according to Embodiment 2. One of the significant features of the chemical application apparatus in Embodiment 2 lies in that a plurality of application nozzles having the same structure as that of the application nozzle 3 in Embodiment 1 shown in FIG. 2 and FIG. 3 are provided to enable application of plural kinds of chemicals onto a substrate by the application nozzles.

As shown in FIG. 4, the chemical application apparatus (application unit) of the present embodiment includes: a wafer chuck (not shown in the drawing) for holding a substrate 11; a first application nozzle 13a and a second application nozzle 13b for applying a first chemical 18a and a second chemical 18b, respectively, onto the substrate 11 held by the wafer chuck; a substrate position measuring mechanism 14 that computes relative positions of the application nozzles 13a, 13b with respect to measurement marks 12 provided on the substrate 11; a computer 15 that stores pattern information for forming a pattern on the substrate 11; and means for performing drive control and chemical supply control on the application nozzles 13a, 13b based on the relative positions of the application nozzles 13a, 13b computed by the substrate position measuring mechanism 14 and the pattern information stored in the computer 15 (for example, this means may be another computer not shown or the computer 15 may serve as this means in addition). The application nozzles 13a, 13b are arranged above the substrate 11 held by the wafer chuck and are capable of moving over the entirety of the substrate 11. Specifically, the application nozzles 13a, 13b can move in a predetermined application direction (X direction) over the substrate 11 and extend in a Y direction perpendicular to the X direction so as to cross over the substrate 11. The length of the application nozzles 13a, 13b in the Y direction (extending direction) is longer than the diameter of a wafer to be the substrate 11. The substrate position measuring mechanism 14 is mounted on one side face extending in the Y direction of the first application nozzle 13a, for example. Wherein, the location of the substrate position measuring mechanism 14 is not limited specifically only if the relative positions of the application nozzles 13a, 13b with respect to the measurement marks 12 can be measured. For example, the substrate position measuring mechanism 14 may be provided in either one of the application nozzles 13a, 13b or in each of the application nozzles 13a, 13b. The computer 15 is mounted on an outer cabinet wall 20 of the application unit, for example.

The chemical application method using the chemical application apparatus (application unit) of the present embodiment shown in FIG. 4 will be descried below. Wherein, the pattern information is stored in the computer 15 in advance before the chemical application processing.

First, the wafer chuck sucks and vacuums the substrate 11 conveyed to the application unit to hold it substantially horizontally. Next, the substrate position measuring mechanism 14 mounted on the first application nozzle 13a measures the positions of the measurement marks 12 provided on the substrate 11 (specifically, relative positions of the measurement marks 12 viewed from a reference position (zero point) in the application unit). It is noted that the reference position can be set arbitrarily and the position of the first application nozzle 13a may be set as the reference position, for example.

The measurement marks 12, of which number is preferably 4 and at least 2, are provided on the substrate 11, and the substrate position measuring mechanism 14 measures position information on the X direction and the Y direction of each measurement mark 12. The substrate position measuring mechanism 14 then performs processing of averaging the measured values to compute the relative positions of the application nozzles 13a, 13b with respect to the measurement marks 12. Under the circumstances, weighting processing is performed to the measured values of the position information of each measurement mark 12 to attain optimum alignment (in other words, accurate computation of the relative positions of the application nozzles 13a, 13b with respect to the measurement marks 12). Specifically, when computation accuracy of the relative positions of the application nozzles 13a, 13b varies depending on the measurement marks 12, a greater weight is applied to the measured value of the position information of a measurement mark 12 from which higher accuracy can be obtained. For example, when measurement mark processing accuracy in the peripheral portion of the substrate 11 is inferior to measurement mark processing accuracy in the central portion of the substrate 11, a greater weight is applied to the measured value of the position information of a measurement mark 12 provided in the central portion of the substrate 11, thereby increasing the computation accuracy of the relative positions of the application nozzles 13a, 13b.

Further, the substrate position measuring mechanism 14 measures the positions of the measurement marks 2 by exchanging diffracted light of laser light and image recognition by an image sensor utilized or the like according to the surface state of the substrate 11. Further, the substrate position measuring mechanism 14 can perform correction of the measured position information of the measurement marks 12 based on a measured result of an overlap state of an underlying pattern and an applied pattern (pattern formed by drying the applied chemicals 18a, 18b) on the substrate 11 after chemical application.

Next, the first application nozzle 13a is allowed to move from one end to the other end of the substrate 11 over the substrate 11. Under the circumstances, based on the pattern information (information on a pattern made of the first chemical 18a) stored in the computer 15 for pattern information storage and the relative position information of the first application nozzle 13a computed by the substrate position measuring mechanism 14, dropping of the first chemical 18a through the first application nozzle 13a is started at the time when the first application nozzle 13a reaches a chemical dropping start point S above the substrate 11, and thereafter, the dropping of the first chemical 18a through the first application nozzle 13a is stopped at the time when the first application nozzle 13a reaches a chemical dropping end point E above the substrate 11. Wherein, drive control and the chemical supply control on the first application nozzle 13a are performed using the computer 15, for example. Further, the thickness of the first chemical 18a applied on the substrate 11 is adjusted according to viscosity of the first chemical 18a, movement speed of the first application nozzle 13a, whether or not the first chemical 18a is being dropped from a nozzle array (see FIG. 3) of the first application nozzle 13a, and the like. In addition, whether the first chemical 18a is to be applied or not in the extending direction (the direction perpendicular to the application direction) of the first application nozzle 13a is adjusted by controlling the dropping of the first chemical 18a from each solution discharge port of the nozzle array of the first application nozzle 13a (control to drop the first chemical 18a from given discharge ports while not to drop the first chemical 18a from other discharge ports).

After a specified time period elapses from the start of the movement of the first application nozzle 13a or after a movement distance of the first application nozzle 13a reaches a predetermined distance, the second application nozzle 13b is allowed to move from the one end to the other end of the substrate 11 over the substrate 11. Under the circumstances, based on the pattern information (information on a pattern made of the second chemical 18b) stored in the computer 15 for pattern information storage and the relative position information of the second application nozzle 13b computed by the substrate position measuring mechanism 14, dropping of the second chemical 18b through the second application nozzle 13b is started at the time when the second application nozzle 13b reaches a chemical dropping start point S above the substrate 11, and thereafter, the dropping of the second chemical 18b through the second application nozzle 13b is stopped when the second application nozzle 13b reaches a chemical dropping end point E above the substrate 11. Wherein, drive control and chemical supply control on the second application nozzle 13b are performed using the computer 15, for example. Further, the thickness of the second chemical 18b applied on the substrate 11 is adjusted according to viscosity of the second chemical 18b, movement speed of the second application nozzle 13b, whether or not the second chemical 18b is being dropped from a nozzle array (see FIG. 3) of the second application nozzle 13b, and the like. In addition, whether the second chemical 18b is to be applied or not in the extending direction (the direction perpendicular to the application direction) of the second application nozzle 13b is adjusted by controlling the dropping of the second chemical 18b from each chemical discharge port of the nozzle array of the second application nozzle 13b (control to drop the second chemical 18b from given discharge ports while not to drop the second chemical 18b from other discharge ports).

As described above, in Embodiment 2 of the present invention, the drive control and the chemical supply control on the application nozzles 13a, 13b are performed nozzle by nozzle independently based on the computed result of the relative positions of the application nozzles 13a, 13b with respect to the measurement marks 12 on the substrate 11 and the pattern information stored in the computer 15, thereby forming a pattern on the substrate 11. Accordingly, a plurality of chemicals (the first chemical 18a and the second chemical 18b) can be applied only in respective desired regions on the substrate 11 by the respective application nozzles 13a, 13b, so that an exposure process and a development process can be eliminated in a case of pattern formation using photosensitive resins as the first chemical 18a and the second chemical 18b. Further, pattern formation using non-photosensitive resins as the chemicals 18a, 18b can be enabled. Hence, a pattern can be formed within a short period of time without using equipment having a complicated structure.

In Embodiment 2, the two kinds of chemicals 18a, 18b are applied onto the substrate 11 as respective single layers. However, the number of times of the movement of the application nozzles 13a, 13b from the one end to the other end of the substrate 11 over the substrate 11 is not limited to 1. Namely, the chemicals 18a, 18b are overlaid in parts or the entireties of the chemical application regions, respectively, by moving the application nozzles 13a, 13b so as to respectively pass along the chemical application region more than one time, obtaining desired thicknesses of the applied chemicals 18a, 18b.

Furthermore, referring to the structure of the application nozzles 13a, 13b, the same structure as that of the application nozzle 3 in Embodiment 1 shown in FIG. 2 and FIG. 3 is employed in Embodiment 2. However, the structure of the application nozzles 13a, 13b is not limited specifically. In addition, three or more application nozzles may be provided in the chemical application apparatus.

### Embodiment 3

A chemical application method and a chemical application apparatus according to Embodiment 3 of the present invention will be described below with reference to the drawings.

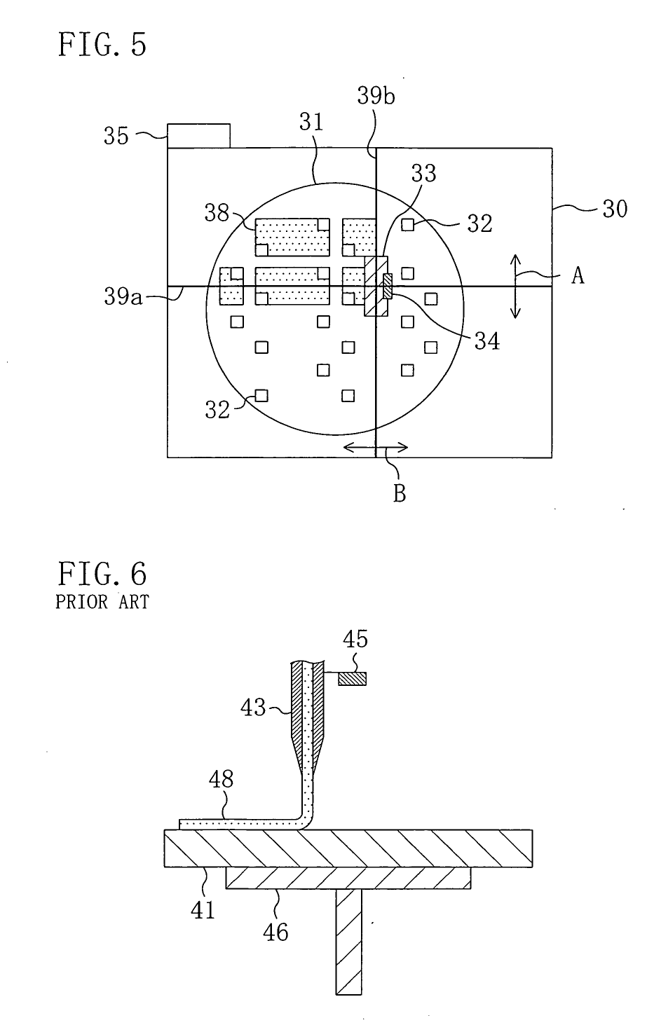

FIG. 5 is a plan view of a main part of the chemical application apparatus according to Embodiment 3. One of the significant features of the chemical application apparatus in Embodiment 3 lies in that a length of an application nozzle in an extending direction is shorter than the diameter of a wafer to be a substrate and that the application nozzle becomes movable freely (two-dimensionally) over the substrate.

As shown in FIG. 5, the chemical application apparatus (application unit) of the present embodiment includes: a wafer chuck (not shown) for holding a substrate 31; an application nozzle 33 for applying a chemical 38 onto the substrate 31 held by the wafer chuck; a substrate position measuring mechanism 34 that computes a relative position of the application nozzle 33 with respect to measurement marks 32 provided on the substrate 31; a computer 35 that stores pattern information for forming a pattern on the substrate 31; and means for performing drive control and chemical supply control on the application nozzle 33 based on the relative position of the application nozzle 33 computed by the substrate position measuring mechanism 34 and the pattern information stored in the computer 35 (for example, this means may be another computer not shown or the computer 35 may serve as this means in addition). The application nozzle 33 is arranged above the substrate 31 held by the wafer chuck and is capable of moving over the entirety of the substrate 31. Specifically, the application nozzle 33 can move in a direction of an arrow A by moving a drive shaft 39a and can move in a direction of an arrow B (direction perpendicular to the direction of the arrow A) by moving a drive shaft 39b. Namely, the application nozzle 33 is movable in two dimensions over the substrate 31. The length of the application nozzle 33 in the direction of the arrow A (extending direction) is shorter than the diameter of a wafer to be the substrate 31. The structure of the discharge face of the application nozzle 33 is basically the same as that of the application nozzle 3 in Embodiment 1 shown in FIG. 3. The substrate position measuring mechanism 34 is mounted on one side face extending in the direction of the arrow A of the application nozzle 33. Wherein, the location of the substrate position measuring mechanism 34 is not limited specifically only if the relative position of the application nozzle 33 with respect to the measurement marks 32 can be measured. The computer 35 is mounted on an outer cabinet wall 30 of the application unit, for example.

The chemical application method using the chemical application apparatus (application unit) of the present embodiment shown in FIG. 5 will be descried below. Wherein, the pattern information is stored in the computer 35 in advance before the chemical application processing.

First, the wafer chuck sucks and vacuums the substrate 31 conveyed to the application unit to hold it substantially horizontally. Next, the substrate position measuring mechanism 34 mounted on the application nozzle 33 measures the positions of the measurement marks 32 provided on the substrate 31 (specifically, relative positions of the measurement marks 32 viewed from a reference position (zero point) in the application unit). It should be noted that the reference position can be set arbitrarily and the position of the application nozzle 33 may be set as the reference position, for example.

The measurement marks 32, of which number is preferably 4 and at least 2, are provided on the substrate 31. The substrate position measuring mechanism 34 measures position information on the X direction (the direction of the arrow B) and the Y direction (the direction perpendicular to the X direction, that is, the direction of the arrow A) of each measurement mark 32. The substrate position measuring mechanism 34 then performs processing of averaging the measured values to compute the relative position of the application nozzle 33 with respect to the measurement marks 32. Under the circumstances, weighting processing is performed to the measured values of the position information of each measurement mark 32 to attain optimum alignment (in other words, accurate computation of the relative position of the application nozzle 33 with respect to the measurement marks 32). Specifically, when computation accuracy of the relative position of the application nozzle 33 varies depending on the measurement marks 32, a greater weight is applied to the measured value of the position information of a measurement mark 32 from which higher accuracy can be obtained. For example, when measurement mark processing accuracy in the peripheral portion of the substrate 31 is inferior to measurement mark processing accuracy in the central portion of the substrate 31, a greater weight is applied to the measured value of the position information of a measurement mark 32 provided in the central portion of the substrate 31, thereby increasing the computation accuracy of the relative position of the application nozzle 33.

Further, the substrate position measuring mechanism 34 measures the positions of the measurement marks 32 by exchanging diffracted light of laser light and image recognition by an image sensor utilized or the like according to the surface state of the substrate 31. Further, the substrate position measuring mechanism 34 can perform correction of the measured position information of the measurement marks 32 based on a measured result of an overlap state of an underlying pattern and an applied pattern (pattern formed by drying the applied chemical 38) on the substrate 31 after chemical application.

Next, the application nozzle 33 is allowed to move from one end to the other end of the substrate 31 in, for example, the direction of the arrow A over the substrate 31. Under the circumstances, based on the pattern information stored in the computer 35 for pattern information storage and the relative position information of the application nozzle 33 computed by the substrate position measuring mechanism 34, dropping of the chemical 38 through the application nozzle 33 is started at the time when the application nozzle 33 reaches a chemical dropping start point S above the substrate 31, and thereafter, the dropping of the chemical 38 through the application nozzle 33 is stopped when the application nozzle 33 reaches a chemical dropping end position E above the substrate 31. Wherein, the drive control and the chemical supply control on the application nozzle 33 are performed using the computer 35, for example. Further, the thickness of the chemical 38 applied on the substrate 31 is adjusted according to viscosity of the chemical 38, movement speed of the application nozzle 33, whether or not the chemical 38 is being dropped from a nozzle array (see FIG. 3) of the application nozzle 33, and the like.

As described above, in Embodiment 3 of the present invention, the drive control and the chemical supply control on the nozzle 33 are performed based on the computed result of the relative position of the application nozzle 33 with respect to the measurement marks 32 on the substrate 31 and the pattern information stored in the computer 35, thereby forming a pattern on the substrate 31. Accordingly, the chemical 38 can be applied only in a desired region on the substrate 31 by the application nozzle 33, so that an exposure process and a development process can be eliminated in a case of pattern formation using a photosensitive resin as the chemical 38. Further, pattern formation using a non-photosensitive resin as the chemical 38 can be enabled. Hence, a pattern can be formed within a short period of time without using equipment having a complicated structure.

In the present embodiment, the movement of the application nozzle 33 is not limited specifically. Namely, in association with respective movement of the drive shafts 39a, 39b in the direction of the arrow A or in the direction of the arrow B, the application nozzle 33 can move freely to a desired position above the substrate 31.

In addition, in the present embodiment, the chemical application apparatus may be structured so that the distance between the substrate 31 and the application nozzle 33 (precisely, the discharge face thereof) is adjustable.

What is claimed is:

1. A chemical application apparatus comprising:
holding means which holds a substrate;
an application nozzle which is capable of moving over the substrate held by the holding means and which supplies a chemical onto a surface of the substrate;
storage means which stores pattern information for forming a pattern on the substrate;
position computing means which computes a relative position of the application nozzle with respect to a measurement mark provided on the substrate; and
control means which forms the pattern by applying the chemical onto the substrate through the application nozzle based on the relative position computed by the position computing means and the pattern information stored in the storage means.

2. The chemical application apparatus of claim 1, wherein
the application nozzle includes a discharge port for discharging the chemical, a discharge port for discharging a solvent that dissolves the chemical, a sucking port for sucking a waste fluid, and a discharge port for discharging a gas.

3. The chemical application apparatus of claim 1, wherein
the application nozzle includes a plurality of application nozzles, each of which is drive controlled independently.

4. A chemical application method, comprising:
a step (a) of storing pattern information for forming a pattern on a substrate into storage means;
a step (b) of computing a relative position of an application nozzle with respect to a measurement mark provided on the substrate; and
a step (c) of forming the pattern by applying a chemical onto the substrate through the application nozzle based on the relative position and the pattern information.

5. The chemical application method of claim 4, wherein
the step (c) includes the step of overlaying the chemical in a predetermined region by moving the application nozzle so as to pass along the predetermined region more than one time.

6. The chemical application method of claim 4, wherein
the step (c) includes the step of applying two or more kinds of chemicals onto the substrate through the application nozzle.

7. The chemical application method of claim 4, wherein
the step (c) includes the step of applying a solvent for dissolving the chemical onto the substrate through the application nozzle while removing excessive part of the chemical applied onto the substrate based on the pattern information.

8. The chemical application method of claim 7, wherein
the step (c) includes the step of removing by sucking the chemical dissolved in the solvent through the application nozzle.
